(19) United States
(12) Patent Application Publication
(10) Pub. No.: US 2010/0149036 A1
(43) Pub. Date: Jun. 17, 2010

(54) System and Methods for Using Current and Past Positional Data to Provide Advanced Spatial and Temporal Information and Unique Location Based Services

(76) Inventor: Craig Rosenberg, Shoreline, WA (US)

Correspondence Address: JD Patent, 3179 Regent Street, Richmond, BC, V7E 2M7, CA

(21) Appl. No.: 12/625,494

(22) Filed: Nov. 24, 2009

Related U.S. Application Data
(60) Provisional application No. 61/117,571, filed on Nov. 24, 2008.

(51) Int. Cl. G01S 19/14

(52) U.S. Cl. 342/357.13

(57) ABSTRACT

A system and methods for using current and past positional data to provide spatial and temporal information is provided. The inventive system and methods use stored GPS data to provide users with location-based services such as information on when a user was at a particular location, where the user was at a particular time in the past, along with the identity and location of other users. Statistics and forecasts derived from stored GPS data are also within the embodiments of the present invention.

### PRIOR APPLICATIONS

This application claims the benefit of priority of U.S. Provisional Patent Application No. 61/117,571, filed Nov. 24, 2008, the contents of which are hereby incorporated by reference herein.

### FIELD OF THE INVENTION

The field of the present invention relates to the use of positional data to provide spatial and temporal information and location based services. In particular, methods are provided for querying GPS data for the purpose of analyzing a user's path history and extracting valuable information.

### BACKGROUND

Various applications of GPS technology are known in the art. Many GPS applications allow users to pinpoint their current position. For example, Garmin Nuvi® devices allow drivers to see their current position on a street map and Garmin Geko devices allow hikers and backpackers to see their current position on a trail.

Some GPS applications also allow users to store their GPS history. For example, the Pocket Track Pro from Lightning GPS is a small handheld device that can be carried or placed in a vehicle where it will store up to 100 hours of positional data. The data can then be uploaded to a computer via a USB connection and viewed on a computer.

A limited number of known applications allow users to share their GPS positions with others. For example, GPSed offers a mobile service that allows users to share their current GPS positions along with position-tagged photos with other individuals via utilities such as Facebook, MySpace and Twitter.

One significant drawback of present day UPS technologies, however, is that no known applications allow a user to query its GPS path history in order to mine data. For example, users cannot employ current technology to find out where they were at a particular point in time in the past or when, in the past, they were at a particular place. In addition, users are not able to determine, based upon the mining of stored positional data, whether or not they have crossed paths with a particular person before, and if so, when and where.

Moreover, there is an untapped market that GPS service providers could exploit through the use of the invention disclosed herein. If providers were able to aggregate and mine users' GPS data, they could, given permission from the users, sell the users' information to advertisers or provide the raw positional data from groups of users without providing any personally identifiable information. In turn, the advertisers would be able to advertise in particular locations where they know users congregate. Advertisers would also be able to push advertising content to users' mobile devices that was relevant to the users' current position, or push content to specific users who frequent places that the advertisers are targeting.

Accordingly, it is desired to have a GPS application that allows users to query GPS data for past positional and temporal information, both in reference to their own GPS data and also relative to that of other users. GPS service providers would also benefit from a GPS application that would allow them to aggregate and query positional data and then provide the extracted data to third party service providers, such as advertisers.

### BRIEF DESCRIPTION OF THE DRAWINGS

FIG. 1 shows a flow diagram of a user querying the application to determine where the user was at a particular time, along with screen shots on a mobile device of the application being queried according to the flow diagram.

FIG. 2 shows a flow diagram of a user querying the application to determine when the user was at a particular location, along with screen shots on a mobile device of the application being queried according to the flow diagram.

FIG. 2A shows a flow diagram of a user obtaining statistics based upon stored GPS data.

FIG. 2B shows a flow diagram of a user obtaining forecasts based upon stored GPS data.

FIG. 3 shows a flow diagram of a user querying the application to determine what other users of the application that historically like to frequent a particular location at a particular set of times, along with a screen shot on an exemplary web browser of the application being queried according to the flow diagram.

FIG. 4 shows a flow diagram of an advertiser querying aggregated user data to determine user traffic near the advertiser's place of business.

FIG. 5 shows a flow diagram of a user receiving a targeted message or offer from an advertiser when the user is near the advertiser's place of business.

FIG. 6 shows a flow diagram of a user querying the application to determine whether he has met a particular user in the past, along with a screen shot on an exemplary web browser of the application being queried according to the flow diagram.

FIG. 7 shows a flow diagram of a user sharing her GPS path with another user or, in the alternative, a user monitoring the GPS path of another user.

FIG. 8 shows a flow diagram of a user finding particular locations based upon GPS path history.

### DETAILED DESCRIPTION OF THE INVENTION

For purposes of the present description of the various inventive embodiments, “GPS data” shall mean any data obtained using a device that tracks position using the global positioning system. “GPS device” shall mean any device that tracks position using the global positioning system. “GPS application” shall mean any software that tracks and uses GPS data. These definitions and other terms used herein are not meant to limit in any way the scope of the present invention and are to be construed in the broadest possible way according to the knowledge of one of skill in the art.

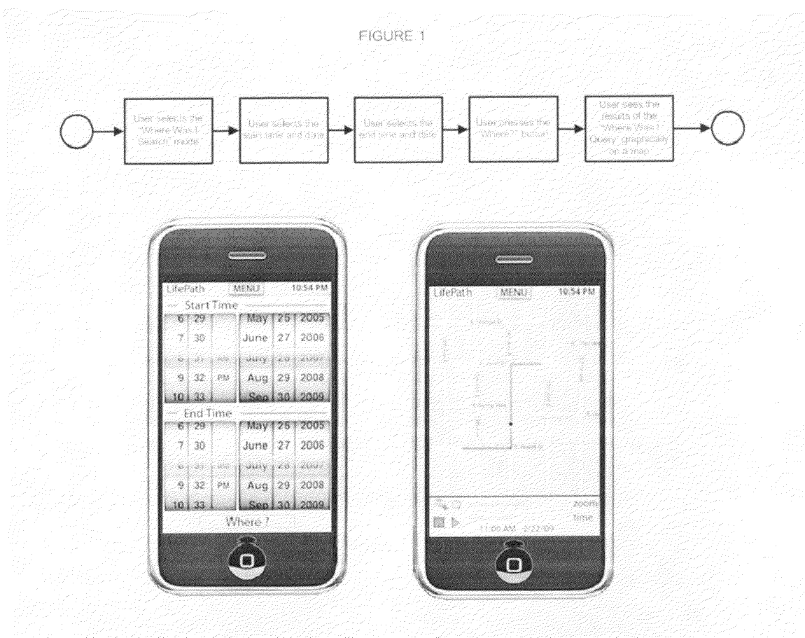

In one embodiment of the present invention, and as shown in FIG. 1, a user may wish to determine where he was at a particular point in time in the past or range of times in the past. Thus, for example, the user may query the application by inputting a particular date and time or range of times as the basis for his inquiry. The application would then consult stored UPS data to determine where the user was located on the date and at the time in question (or time range) and then graphically display the user's position at the date and time and/or the user's path taken during the inputted range of times. By way of example, this may help the user to determine whether he was at a particular business meeting on the date and at the time in question or may help the user recall where he met a particular person.

Specific reference to FIG. 1 shows how a user may query the inventive system to determine where he was at a particular time or during a particular range of times. As shown in the depicted flow diagram, the user may first select the “Where Was I” search mode from the available system modes. Doing so presents the user with a screen such as that depicted on the left-hand mobile device in FIG. 1, where the user can then manipulate the user interface to enter the desired starting and ending dates and times. As shown in the flow diagram, the user may then select the “Where” utility, upon which the inventive system will display output similar to the exemplary results depicted on the right-hand mobile device in FIG. 1. In the example shown in FIG. 1, the user is shown the path he traveled during the full minute of 8:31 AM on Jul. 28, 2007.

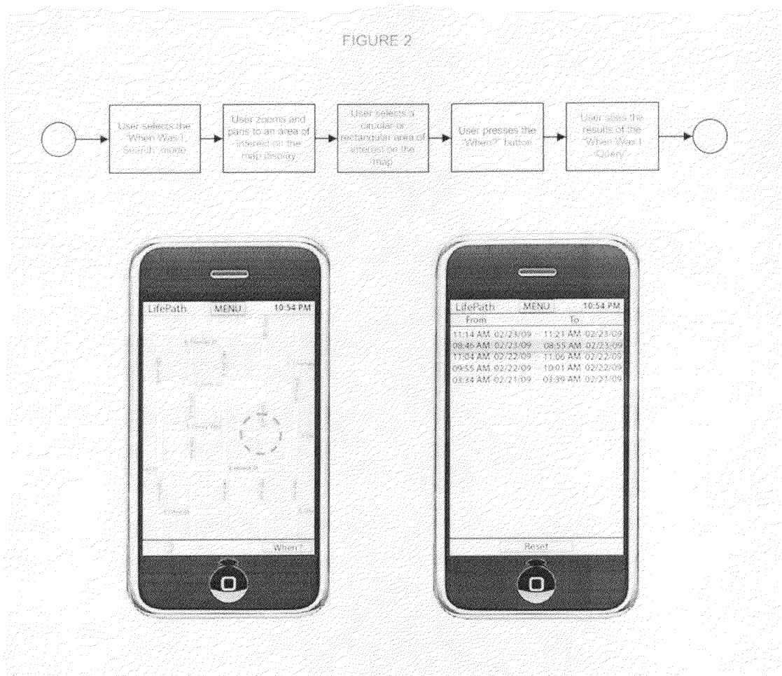

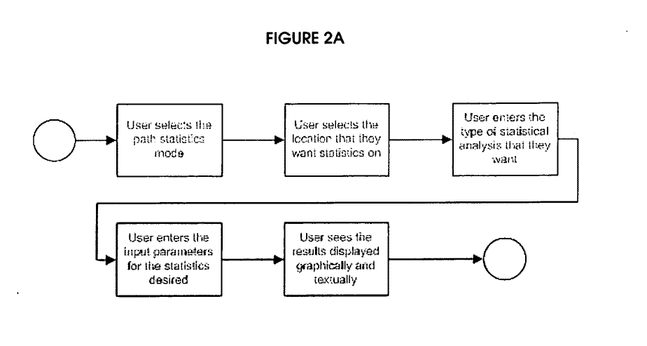

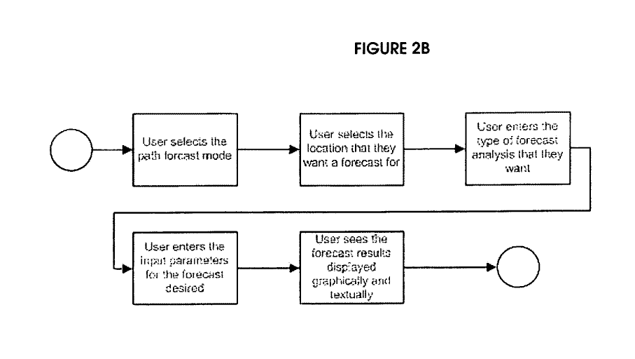

In another embodiment of the present invention, and as shown in FIG. 2, a user may wish to determine when he was at a particular place. Thus, for example, the user may query the application by graphically selecting the particular GPS coordinates or a particular address or a particular business (e.g., a particular coffee shop at the intersection of 7^{th} and Figueroa in Los Angeles). The application would then consult stored GPS data to determine if the user was located at the particular location and if so then display the date and time that they were there. In addition, the application would display more than one date and time if the user frequents the particular location often. By way of example, this may help the user to determine how often he visits a particular location or simply to recall when he visited a particular business or landmark and if so, when.

Specific reference to FIG. 2 shows how a user may query the inventive system to determine when he was at a particular location. As shown in the depicted flow diagram, the user may first select the “When Was I” search mode from the available system modes. Doing so presents the user with a screen such as that depicted on the left-hand mobile device in FIG. 2, where the user can then manipulate the user interface to select a particular circular or rectangular location on the map display, as noted in the third block in the flow diagram. As shown in the flow diagram, the user may then select the “When” utility, upon which the inventive system will display output similar to the exemplary results depicted on the right-hand mobile device in FIG. 2. In the example shown in FIG. 2, the user is shown a number of time ranges on Feb. 21, 22, and 23 of 2009 when he was at or near the intersection of 15th Avenue and Denny Way.

Several variations are possible of the embodiments shown in FIGS. 1 and 2 and described above. Solely by way of example, a user may wish to compute various statistics based upon his past positional data. Thus, as an illustration of this concept, a user may wish to determine how often he went to a particular coffee shop on Saturdays in August between 8:40 AM and 10:25 AM. Accordingly, the flow diagram in FIG. 2A shows that a user may input the positional data and statistical parameters he is interested in and the inventive system will consequently display graphical and textual results corresponding to the statistics of interest to the user.

Similarly, a user may wish to derive forecasts from past positional data. Again solely by way of example, the user may wish to determine the probability that they will be stopped at a particular intersection on any given day of the week. While there are many possible uses for this type of information, perhaps the user would like to generate a forecast such as the foregoing one to analyze whether he is taking the most efficient route to his destination. Accordingly, the flow diagram in FIG. 2B shows that the user may input the positional data and forecast parameters he or she is interested in and the inventive system will provide as output graphical and textual results that are aligned with the forecast of interest to the user.

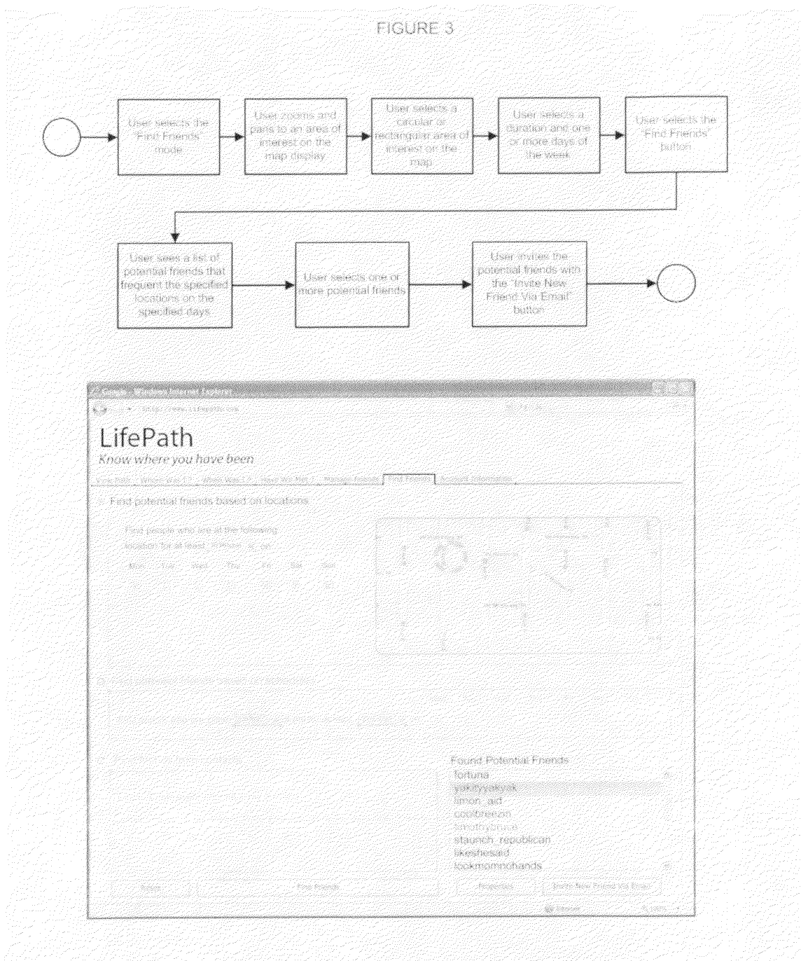

In another embodiment of the present invention, and as shown in FIG. 3, a user may wish to query the application to determine which other users like to frequent a particular location. For example, the user may be looking to meet other like-minded people who like to frequent the same places at the same times as the user. In this embodiment, the user would input a particular location of interest and query the application for a list of other users who like to visit the same location at the specified range of times. The application would then display on either the user's mobile device or the web site, a list of names, screen names, pseudonyms or the like as a method of identifying other users. In order to protect privacy, users would have to opt in to this feature of the inventive system.

Specific reference to FIG. 3 shows how a user may query the inventive system to determine which other users like to frequent a particular location. As shown in the depicted flow diagram, the user may first select the “Find New Friends” search mode from the available system modes. Doing so presents the user with a screen such as that depicted on the web browser interface in FIG. 3. From this point, the user can then manipulate the user interface to select a particular area of interest on the map display, along with a particular time duration and days of the week that are of interest, as noted in the third and fourth blocks in the flow diagram. As shown in the fifth block of the flow diagram, the user may then select the “Find Friends” utility, upon which the inventive system will display output similar to the exemplary results depicted in the lower-right hand corner of the web browser output shown in FIG. 3. In the example shown in FIG. 3, the user is shown a list of several “Potential Friends,” at which point, as shown in the last block of the flow diagram, the user can then contact these potential friends to start a conversation or invite one or more of the “Potential Friends” to join him at the location of interest.

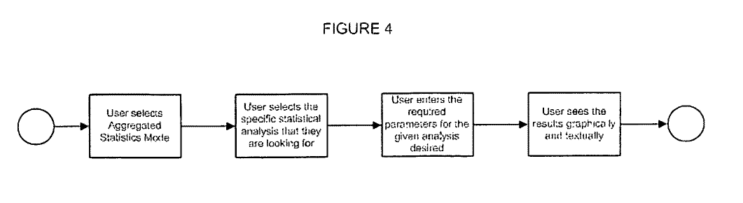

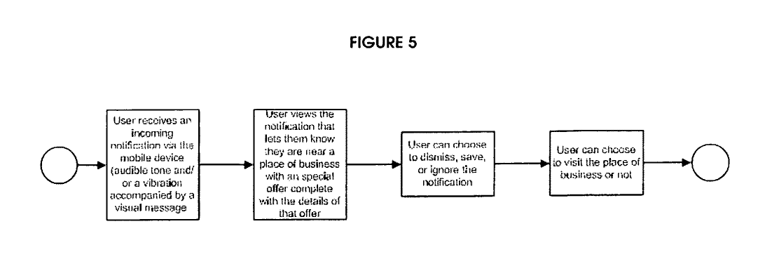

In another embodiment of the present invention, and as show in FIG. 4, an advertiser or business owner may wish to query aggregated user data to determine user traffic near a particular location, such as a place of business or advertising venue (e.g., billboard, bus shelter). Accordingly, the advertiser or business owner would input the location of interest and the application would display a numerical count of all users currently within a specified distance from the location of interest. Alternatively, the application would display a numerical count of all users who had passed within a given distance of the location within a specified period of time or range of times. Alternatively, the application would display the identities of the users who were near the location of interest or had been near the location of interest within a specified period of time. The user's identities could be disclosed in a number of formats, including name, screen name or means of contact (e.g., mobile number or email address). The list of users could also be provided in a format only usable to the application, thus protecting the users' privacy. In this embodiment, the application would provide to the advertiser or business owner a list of identifiers which would, in turn, signify the number of users' satisfying the desired criteria (e.g. at the particular location or passed by the particular location within the past 24 hours). The advertiser, as shown in FIG. 5, could then choose to send an advertisement or offer to the identified user through the application without the actual identity of the relevant users ever being identified to the advertiser. In another variation, the inventive system, based upon knowing a user's GPS position, could send an advertisement or targeted offer to the user when that user is within a given radius of an advertiser's place of business.

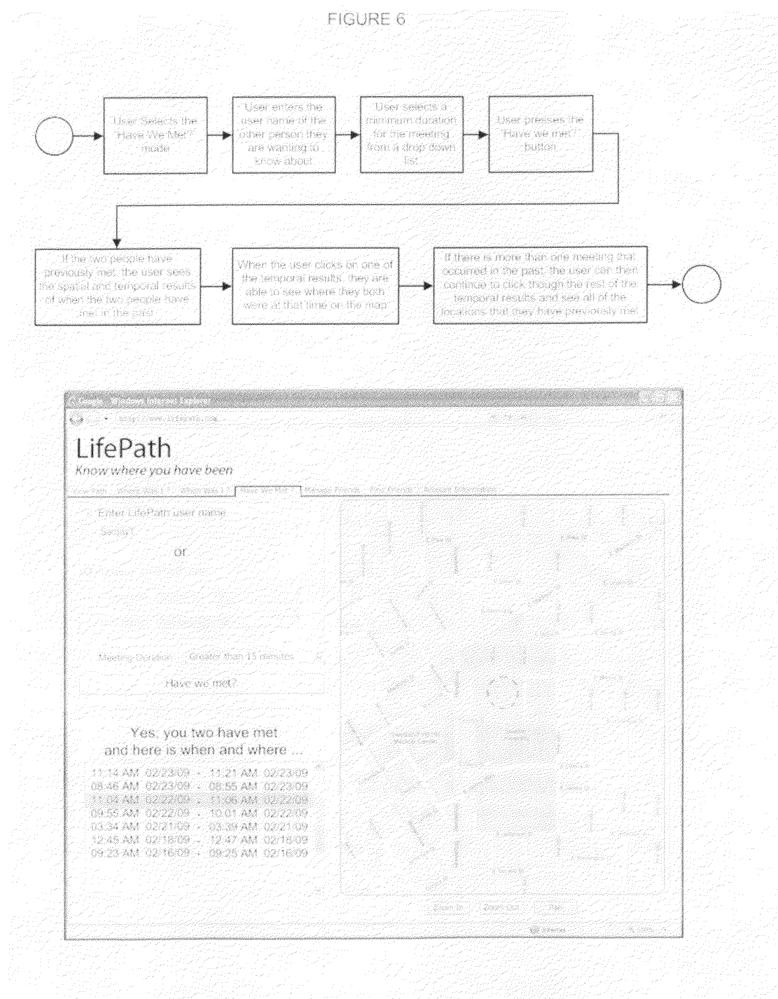

In another embodiment of the present invention, and as shown in FIG. 6, a user may wish to query the application to determine whether he has met a particular other user and, if he has in fact met that other user, when and where they have met. For example, the user may encounter a person who looks familiar and may wish to know whether he has met that person before. In this embodiment, if both users used the inventive system, then the user would input the encountered person's user name and query the application for a list of dates and times upon which the users had previously met. The application would then display on the user's mobile device or computer screen a list of dates and times when the two users had met along with a graphical depiction (i.e. map display) of the locations where the two users had met, if indeed they had met in the past.

Specific reference to FIG. 6 shows how a user may query the inventive system to determine whether he had met a particular user and, if so, when and where they had met. As shown in the depicted flow diagram, the user first selects the “Have We Met?” search mode from the available system modes. Doing so presents the user with a screen that is depicted on the web browser interface in FIG. 6. From this point, the user can then manipulate the user interface to input the user name of the person of interest, along with a minimum duration of meeting (in order, for example, to exclude times when the two users may not have met but simply have passed each other while walking down the street), as noted in the second and third blocks in the flow diagram. As shown in the fourth block of the flow diagram, the user can then select the “Have We Met?” utility, upon which the inventive system will display output similar to the exemplary results depicted in the lower-left hand corner of the web browser output shown in FIG. 6. In the example shown in FIG. 6, the user is shown a list of several dates and times when the two users have previously met, at which point the user is able to select one of those instances from the list and the inventive system will then graphically display the location of the particular meeting on a map interface. In the exemplary depiction in FIG. 6, the right-hand side of the web browser output shows the user that he met the user of interest on the campus of Seattle University between 11:04 AM and 11:06 AM on Feb. 22, 2009.

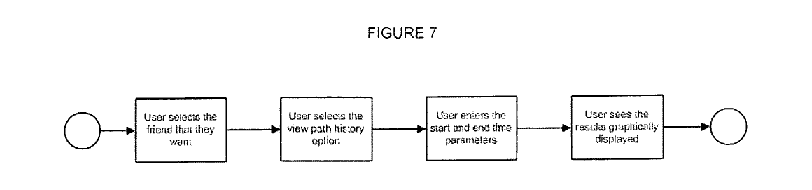

Several additional embodiments are contemplated by the present invention. For example, a user may wish to share her GPS path with another user or, conversely, a user may wish to monitor the GPS path of another user. For example, a parent may wish to monitor the GPS path of one of his children and, depending on the child's age, the child may provide permissions through the inventive system for the tracking to take place. According to this embodiment, the parent may wish to know whether his child completed her journey to a friend's house and, perhaps, whether she made a planned stop along the way. FIG. 7 shows one possible use of this embodiment of the invention. The parent user may select his child out of a list of “friends” who are also users of the system. The parent user may then select the “View Path History” option and also enter the start and end time parameters. The system will then consequently display the path history of the child user during the inputted time parameters, thus providing the parent with a graphical view of whether the child has reached its destination and whether it made planned stops along the way. Amongst other things, this provides the parent with a non-intrusive way of monitoring his child's safety.

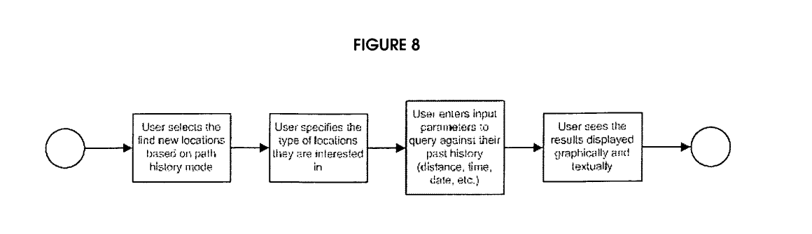

Also in accordance with the present invention, the system may provide a user with the names and locations of businesses of a specific type that are within a given distance of the user's GPS path history. For purposes of illustration, a user may wish to be provided with a listing of all coffee shops that are within a quarter mile of the normal route that she takes to work in order to decide where to obtain her morning coffee. In this embodiment, the system would be mining the user's past GPS data and then comparing that data against corresponding map data to generate a list of coffee shops that fall within the given parameters. Accordingly, and with reference to FIG. 8, the user would select the “Find New Locations Based on Path History” mode of the inventive system and then specify the type of location of interest along with inputting various parameters for her request, such as date, time and desired distance from her GPS path. Working from the user's input and from map data, the system then provides a graphical and textual display corresponding, in this case, to a list of coffee shops within a quarter mile of the user's normal route taken to work.

The present invention has been set forth in the form of various exemplary embodiments. One of skill in the art will readily understand that various alternate embodiments are possible and are contained within the scope of the present invention. Modifications to the disclosed system and methods for using positional data may be made without departing from the inventive concepts disclosed herein. For example, steps described in the various embodiments and shown the drawings may, in some cases, be performed in a different order. While not in any way limited to the particular embodiments disclosed herein, the present invention has been described in terms of currently available GPS technology, mobile devices and internet applications. One of skill in the art will understand that these are rapidly evolving areas of technology and that advances in these areas of technology will still be able to draw on the various embodiments of the invention disclosed herein. For example, while many of the illustrations of the current invention show its deployment on an Apple iPhone, the invention is equally suitable to any other mobile devices with GPS and internet connectivity.

One of skill in the art will also understand that the system of the present invention may be deployed on a computer system with an input means, processing means and output display means such as that found in a desktop computer, laptop or notebook computer, or a mobile device such as a cellular phone, smartphone, embedded device, or the like. In this regard, the system is meant to be used in conjunction with GPS and mapping technology as a new application, modification or deployment thereof. Accordingly, the embodiments disclosed herein are exemplary in nature and the scope of the following claims is not in any way limited to the described embodiments.

What is claimed is:

1. A system for using GPS data to provide location based services, comprising:
a GPS device;
stored GPS data; and
a means for querying the stored GPS data.

2. The system of claim 1, wherein the stored GPS data can be queried for past positional and temporal information.

3. The system of claim 1, wherein the stored GPS data can be used to provide a list of users who have been at a particular location.

4. The system of claim 1, wherein the stored GPS data can be queried to determine a user's position at a particular point in time.

5. The system of claim 1, wherein the stored GPS data can be queried to when a user was at a particular position.

6. A method of querying GPS data, comprising:
providing stored GPS data including past positional and temporal information;
querying, the stored GPS data with particular criteria associated with a point in time or a specified location; and
providing a response comprising positional or temporal information or information about a user or a plurality of users.

7. The method of claim 6, wherein the stored GPS data is queried for aggregated past positional and temporal information.

8. The method of claim 7, wherein the aggregated data can be used to provide a list of users who have been at a particular location.

9. The method of claim 6, wherein the response comprises a user's past position at a particular point in time.

10. The method of claim 6, wherein the response comprises the time, or set of times when a user was at a particular position.

11. The method of claim 6, wherein the response comprises the position of a plurality of users.

12. The method of claim 11, wherein the response also comprises the time at which the plurality of users were at the position.
